(19) United States
(12) Patent Application Publication
(10) Pub. No.: US 2011/0030690 A1
(43) Pub. Date: Feb. 10, 2011

(54) Water absorbing face mask

(76) Inventors: Kavita M. Shukla, Ellicott City, MD (US); Ashok K. Shukla, Ellicott City, MD (US); Mukta M. Shukla, Ellicott City, MD (US)

Correspondence Address: ASHOK K. SHUKLA, 10316 KINGSWAY COURT, ELLICOTT CITY, MD, 21042, US

(21) Appl. No.: 12/800,553

(22) Filed: May 18, 2010

Related U.S. Application Data
(60) Provisional application No. 61/216,286, filed on May 18, 2009.

(51) Int. Cl. A62B 18/08

(52) U.S. Cl. 128/206.12

(57) ABSTRACT

The present invention is a mask coated with water absorbing material for preventing or reducing the transmission of infections such as flu, viral and bacterial pathogens which can be transmitted from human to human or animal to human or human to animal through saliva, nasal fluid or inhalation.

This Application (Applicants) claims the benefit of priority date May 18, 2009 of provisional application No. 61/216,286

### FIELD OF THE INVENTION

The present invention is for preventing or reducing the transmission of infections such as flu, viral and bacterial pathogens which can be transmitted from human to human or animal to human or human to animal contact through saliva, nasal fluid or inhalation. Since the virus or bacteria causing such infections are often present in aerosolized media such as saliva ejected during sneezing or breathing or coughing, wearing a mask over the mouth and/or nose can be an effective method for preventing or reducing the transmission of disease causing pathogens or viruses. However, the pores in a mask can be larger than virus or bacteria leading to limited utility and leaving the possibility of transmission open despite providing a crude protective barrier. The mask coated with the water-absorbing material can absorb the aerosolized media more effectively than the mask alone.

### BACKGROUND INFORMATION

The prevention method for the infection is generally by hand washing and by using the mask. The Role of the mask is to prevent the aerosolized saliva from getting in contact with healthy non infected human. Such masks are simple filters that filter the particles. Sometimes these aerosolized droplets are so small that they can not be filtered through the mask. The speed of such aerosolized particles are also very high during the sneezing (up to 100 miles per hour. To prevent the said aerosol particles from entering or exiting a mask with very fine pores is required to prevent the transfer of the disease causing pathogens. This invention describes the use of a enhanced or improved mask, gloves, and other coverings used to prevent or reduce transmission of infectious agents.

In one embodiment of this invention, the mask is coated or impregnated with a water or aqueous media absorbing material. This will bind the aerosol droplet more effectively and enhance the preventive property of the mask. Because when the aqueous aerosol droplet will get in contact with the water absorbing surface, it will stick to the water absorbing coating and the virus or bacteria in the aerosol will also be trapped on the water absorbing surface. This will prevent the pathogen from getting in contact with the healthy, non infected person. Or if such a coated mask is used by a diseased or infected person, it will prevent the pathogen from escaping into atmosphere to infect the other person.

Various features of novelty that characterize the present invention are pointed out with particularity in the claims annexed to and forming a part of this disclosure. For a better understanding of the invention, its advantages and objectives, reference is made to the accompanying drawings and descriptive matter in which a preferred embodiment of the invention is illustrated.

### BRIEF DESCRIPTION OF THE DRAWINGS

The foregoing and still other objects of this invention will become apparent, along with various advantages and features of novelty residing in the present embodiments, from a study of the following drawings, in which:

FIG. 1 is an expanded view of one embodiment of a face mask with the water absorbing coating either on one side or both sides, according to the present invention.

### DESCRIPTION OF THE PREFERRED EMBODIMENTS

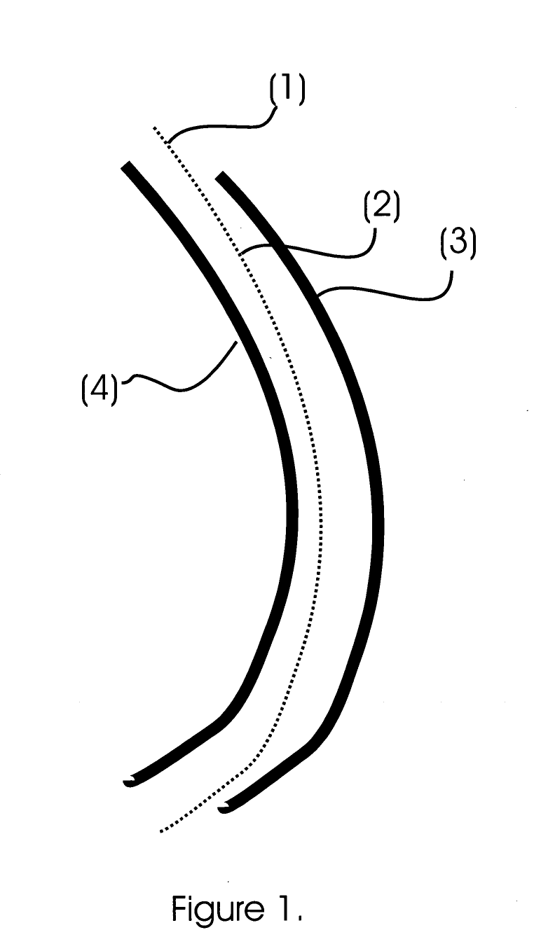

Referring to the drawings, FIG. 1 shows a face mask (1), which contains pores (2) for breathing and a water absorbing coating on the outside (3) and water absorbing coating inside (4).

The said face mask (1) is made of natural or synthetic material. The pores (2) of the mask can be of different sizes 1-1000 micrometer and can be any shape. It can be in hole, woven, or in layer form.

In one embodiment of this invention, a water or aqueous media absorbing material is added to the mask (1). The aqueous media include but are not limited to saliva, nasal fluids, cough. The absorbing material is designed to absorb the aqueous media containing pathogens thus preventing or reducing their further propagation from the host/source (i.e. sick infected human to healthy, uninfected human). The water or aqueous media absorbing material can be a mucin, natural polymer such as gum, galactomannan, substances derived from plant material and synthetic polymers (which absorb water). One example is using an extract from fenugreek seeds since they have strong water absorbing properties. The absorbing material could also be derived from other natural media such bird nests since those contain poly sialic acid. These natural (or potentially synthetic) absorbing materials can be positively or negatively charged or neutral or a combination of the above.

Furthermore, the absorbing material may contain molecules or specific substances or biomolecules which are capable of binding virus, bacteria and other pathogens (i.e. parasites). One example of this is the fact that sialic acid containing mucin (such as found in a bird nest) can bind the influenza virus. The presence of such absorbing materials and binding molecules can be helpful for preventing infections since, for example, influenza virus needs sialic acid to bind to a cell surface and would thus be prevented from being transmitted beyond the barrier of the mask.

These binding or affinity molecules for the infectious agent such as a virus or bacteria can be either present or embedded in the material comprising a protective barrier such as a mask or gloves or can be present or embedded in polymers, mucin or other water or aqueous media absorbing materials as described above. In addition the absorbing material can be modified through chemical or biochemical reactions. Either naturally obtained or modified mucins or polymers can be used for the applications described herein.

In addition, the protective barrier described herein could be a mask, gloves, handkerchief, tissue paper or any other material used to prevent or provide a barrier to the transmission of infectious agents.

The invention described herein an absorbing material with or without a binding substance could also be developed as a spray to be applied to surfaces that could serve as potential methods for transmitting infections such as furniture, door handles etc.

The absorbing material can be embedded or incorporated into the protective barrier such as mask during the manufacturing process or through surface application by coating, spraying or any other methods that lead to the development of the invention described herein.

In addition, one or more pathogen specific binding filters can be used in combination to reduce or prevent the transmission of infectious agents. Such filters could also be applied to fluids such as drinking water or bottle caps to remove potentially infectious agents

While a specific embodiment of the invention has been shown and described in detail to illustrate the application of the principles of the invention, it will be understood that the invention may be embodied otherwise without departing from such principles and various modifications, alternate constructions, and equivalents will occur to those skilled in the art given the benefit of this disclosure. Thus, the invention is not limited to the specific embodiment described herein, but is defined by the appended claims.

What is claimed is:

1. A face mask containing pores for breathing that also contains water absorbing coating to absorb the aqueous aerosolized media such as saliva ejected during sneezing or breathing or coughing, whereby said water absorbing coating enhances the prevention of infection.

2. The face mask as in claim 1 wherein said coating can be only on one side.

3. The face mask as in claim 1 wherein said coating can be on both sides.

4. The face mask as in claim 1, wherein said mask is made of at least one type of porous material selected from the group comprised of natural, synthetic ,cotton, jute, linen, synthetic sheets, synthetic polymers, natural foam, synthetic foam and combinations thereof.

5. The pores as in claim 4, wherein said pores are between 1-1000 micrometer.

6. The aqueous media as in claim 1, wherein, said aqueous media is saliva, nasal fluids, cough, sweat.

7. The mask as in claim 1, wherein the said water absorbing coating material selected from the group comprised of a mucin, natural polymer, synthetic polymer, gum, galactomannan, substances derived from plant material and combinations thereof.

8. The mask in claim 1, wherein, the said water absorbing coating material is purified or whole extract from fenugreek seeds.

9. The mask in claim 1, wherein said water absorbing coating contains binding or affinity molecules for the infectious agent such as a virus or bacteria.

10. The mask in claim 1, wherein, said water absorbing coating is performed selected from the group comprised of, spray, embedding, impregnating, coating, woven and combinations thereof.

11. The face mask as in claim 1 wherein said coating can be only at a partial surface.
